(19) United States
(12) Patent Application Publication
(10) Pub. No.: US 2005/0114398 A1
(43) Pub. Date: May 26, 2005

(54) Computer-aided visualization and analysis system for signaling and metabolic pathways

(75) Inventors: Prashant Shamba Naik, Bangalore (IN); Kasargod Shyamsunder Guruprasad Rao, Bangalore (IN); Satish Patil, Bangalore (IN); Rahul Chandrakar, Bangalore (IN); Rimjhim Das Gupta, Bangalore (IN); Rashmi Nagaraj, Bangalore (IN)

Correspondence Address: FOLEY AND LARDNER;SUITE 500, 3000 K STREET NW, WASHINGTON, DC, 20007, US

(73) Assignee: JUBILANT BIOSYS LIMITED

(21) Appl. No.: 10/960,697

(22) Filed: Oct. 8, 2004

Related U.S. Application Data
(60) Provisional application No. 60/509,956, filed on Oct. 10, 2003.

(51) Int. Cl. G06F 7/00

(52) U.S. Cl. 707/104.1

(57) ABSTRACT

A computer system and a method for analysis and visualization of signalling and metabolic pathways, comprising inter-related databases including external database, a pathway database for storing curated signalling interaction between the biological entities and biological entity data, said databases including a pathart database, a curator member to generate curated signalling interaction between the biological entities obtained from external sources, said pathway database comprising a hierarchical arrangement of signalling interactions among the biological entities and biological entity data, said pathart database to store mapped addresses for hierarchically arranged signalling interactions among the biological entities and biological entity data, a processing system including a server module to fetch and/or generate desired pathways dynamically from the stored signalling interactions and biological entities, said processing system to obtain information on the selected biological entities or their interactions from said dynamic pathways, a user interface for creating, querying, and viewing the dynamic pathways, and micro array data captured by a user.

### TECHNICAL FIELD

The present invention relates to a computer-aided system and method for for analysis and visualization of signalling and metabolic pathways. The present invention particularly relates to a system and a method for pathway, component and micro-array analysis and visualization of signaling and metabolic pathways.

### BACKGROUND AND PRIOR ART

The physiological functions of an organism are accomplished through coordinated regulation of complex networks, which occur at multiple levels. Homeostasis is maintained through the coordinated cell-cell signaling network potentiated through chemical signals.

Intracellular signaling pathways communicate extra cellular information to modulate cellular functions in response to external stimuli. Biomolecular interactions serve not only as a basis to transmit information but also to process the information as it is being transmitted. Such processing occurs due to interaction between various signaling pathways thus weaving a huge network. Such networks are quite complex and may have properties that are non intuitive.

Understanding such complex network becomes increasingly important as it gives us the much needed insights of the molecular pathogenesis of a disease and more so the cause-effect relationship of an individual entity in a system. Thus, intelligent, swift and logical research based products would hasten the understanding and helps to derive logical conclusions for designing more effective approaches for targeting the disease.

The advent of wide range of molecular tools and powerful computers provides us with unprecedented capacity to generate data that reveals the architecture of genomes, genes, traits and how these influence the cellular and molecular processes to bring about the desired phenotypic changes in an organism. The development of micro-array technologies provides a powerful tool by which the expression patterns of thousands of genes can be monitored simultaneously. Comparison of expression arrays from different tissue samples is proving to be quite useful in providing insight into and information about the important genes and their function. To analyze and make sense of this data, we need computers and sophisticated algorithms.

In recent years, the field of bioinformatics has emerged to meet these challenges. By definition, bioinformatics is the science of turning biological data into information. A combination of computer science, information technology, and molecular biology, bioinformatics allows researches to quickly access and interpret a rising tide of genomic information. This is critical for the genomic era: scientists are sequencing the genomes of many species, but they know little about how great regions of these genomes and the proteins they give rise to actually function.

With increase in data, there is an ever increasing demand for storage analysis and retrieval of the data in the form of databases.

The most commonly used public domain databases such as EMBL (The EMBL Nucleotide Sequence Database (also known as EMBL-Bank) constitutes Europe's primary nucleotide sequence resource. Main sources for DNA and RNA sequences are direct submissions from individual researchers, genome sequencing projects and patent applications.(http://www.ebi.ac.uk/embl/), GenBank (GenBank® is the NIH genetic sequence database, an annotated collection of all publicly available DNA sequences. GenBank is part of the International Nucleotide Sequence Database Collaboration, which comprises the DNA DataBank of Japan (DDBJ), the European Molecular Biology Laboratory (EMBL), and GenBank at NCBI; http://www.ncbi.nlm.nih.gov/Genbank/), PIR-NRL3D (The PIR-NRL3D Sequence-Structure Database is produced by PIR-International from sequence and annotation information extracted from three-dimensional structures in the Protein Databank (PDB); http://pir.georgetown.edu/pirwww/); PDB (protein and nucleic acid three-dimensional structures; http://www.rcsb.org/pdb/); OWL (OWL is a non-redundant composite of 4 publicly-available primary sources: SWISS-PROT, PIR, GenBank (translation) and NRL-3D; http://bioinfman.ac.uk/dbbrowser/OWL/); Swiss-Prot (a curated protein sequence database which strives to provide a high level of annotation (such as the description of the function of a protein, its domains structure, post-translational modifications, variants, etc.), a minimal level of redundancy and high level of integration with other databases; http://us.expasy.org/sprot/); TrEMBL (a computer-annotated supplement of Swiss-Prot that contains all the translations of EMBL nucleotide sequence entries not yet integrated in Swiss-Prot; http://us.expasy.org/sprot/) etc., contain genomic, proteomic, biochemical, chemical, and molecular biological data as well as structural data comprising geometric and anatomical information from the sub-cellular localization to the molecular function of the biological entity. The databases allow researchers to search online for a given gene's composition, proteins, mutations, coverage in the scientific literature, and many other relevant parameters that are collectively termed “annotation”. Integrating such information from varied resources will be of vital importance for a single point access to all the related information, as described by Maauley et al., A Model System for studying the Integration of Molecular Biology Databases, 14 Bioinformatics, 575 (1998).

However, understanding gene structure and its function is not just sufficient enough to understand how these genes interact with each other in a regulatory network to modulate the cellular processes. One such approach is found in the PATHDB program available from the National Centre for Genome Resources (http://www.ncgr.org/pathdb). PathDB is a beta level research tool for scientists interested in analyzing their experimental or computational data in the context of biological pathways and networks. The main data types represented by PathDB are compounds, reactions, enzymes and other metabolic proteins and pathways. Similar metabolic pathway databases containing gene sequences data and other biochemical information include EMP and MPW, which are available from the Argonne National Laboratory Computational Biology Group. (http://emp.mcs.anl.gov/; http://wit.mcs.anl.gov/MPW)

One of the best repositories for protein-protein interactions is the Biomolecular Interaction Network Database, is a collection of records documenting molecular interactions. The contents of BIND include high-throughput data submissions and hand-curated information gathered from the scientific literature, coordinated in part by Genome Canada, a genomic research organization based in Ottawa. (http://www.bind.ca/).

Protein-protein interaction data is increasing enormously in volume at an unpredictable rate. Such proteomic data from various sources is available in text files or databases. Due to its volume, the data can be understood or interpreted more easily if expressed into graphs rather than a long list of proteins. Efforts are on to provide better visualizations to depict protein-protein interactions in form of 2D and 3D graph. For e.g., A method for partitioned layout of interaction networks, as described in U.S. Pat. No. 59,522 A1 have been used to represent protein interaction networks into a three dimensional graph.

Other layout algorithm for depicting protein-protein interaction data in the form of graphs is the Spring-force layout algorithm and Sugiyama algorithm. The class SpringLayout represents the spring embedded layout algorithm by Fruchterman and Reingold [Graph Drawing by Force-Directed Placement, Software—Practice and Experience 21, pp. 1129-1164, 1991]. This algorithm draws a general graph G straight-line. The drawing of a planar graph must contain crossings. The idea of the algorithm is the one of simulating a system of mass particles. The vertices simulate mass points repelling each other and the edges simulate springs with attracting forces. The algorithm tries to minimize the energy of this physical system. The Sugiyama layout is a very popular and fast layout algorithms. The class Sugiyama Layout represents a general framework for drawing graphs with the hierarchical drawing method suggested by Sugiyama, How to Draw a Directed Graph, Journal of Information Processing, 13 (4), pp. 424-437, 1990.

Many biological functions are accomplished by altering the expression of various genes through transcriptional and/or translational control. The fundamental biological processes including cell cycle progression and regulation, cell differentiation and cell death are characterized by the variations in gene expression levels. However, expression of a particular gene is regulated by the coordinated interaction of large number of regulatory proteins. Understanding such complex protein-protein interactions in the form of regulatory networks or molecular pathways becomes increasingly important as it gives us the much needed insights of the molecular pathways. This also becomes increasingly important as it gives us the much needed insights of the molecular pathogenesis of a disease and more so the cause-effect relationship of an individual entity in a system. The assessment of large scale gene expression studies is enabled by high through put gene expression studies such as microarray, SAGE, etc.

Analysis, visualization and mapping of gene expression data on maps of known metabolic and signaling pathways is vital significance in understanding the biological relevance of gene expression. One such software tool, Gene MicroArray Pathway Profiler (GENMAPP) (http://www.genmapp.org/), is a free computer application designed to visualize gene expression and other genomic data on maps representing biological pathways and groupings of genes. Integrated with GenMAPP are programs to perform a global analysis of gene expression or genomic data in the context of hundreds of pathway MAPPs and thousands of Gene Ontology Terms (MAPPFinder), import lists of genes/proteins to build new MAPPs (MAPPBuilder), and export archives of MAPPs and expression/genomic data to the web. It has been developed by Gladstone-Genome, University of California at San Francisco.

The other such commercially available software is TRANSPATH®/NetProTM database which provide information about signal transduction pathways, in particular those that aim at transcription regulatory components.

On the other hand, the disease or the physiology specific networks are the missing links in such software.

Citation of a reference herein shall not be construed as an admission that such reference is prior art to the present invention.

### OBJECTS OF THE INVENTION

The primary object of the present invention is to provide a computer-aided system for analysis and visualization of signaling and metabolic pathways of biological entities.

An object of the present invention is to provide a computer-aided method for pathway and component search, micro-array data analysis and visualization of signaling and metabolic pathways.

Another object of the present invention is to provide information on regulatory and signalling pathways across species, information on all participating biomolecules, high priority diseases and disease responsive genes and knowledge databases.

Yet another object of the present invention is to provide pathway visualization in terms of biological entities and interactions between the biological entities.

Further object of the present invention is to identify all the genes in a network directly or indirectly influencing the disease/physiological disorder.

Another object of the present invention is to secure regulatory information stimulated by a trigger or condition in a disease/physiological disorder.

Still another object of the present invention is to identify the critical genes implicated in a disease/physiological disorder.

Further object of the invention is to provide pathways specific to a disease/physiology, organism, organ, tissue or cell line/cell type.

Another object of the present invention is to provide pathway search based on organism, disease, physiology, pathway name, etc.

Yet another object of the present invention is to provide micro-array data analysis based on genes and their expression data.

Still another object of the present invention is its ability to inter operate with statistical visualisation packages like Spotfire, Genespring, etc. for customised analysis of microarray expression data and mapping refined expression data on to pathways to find its biological relevance.

Further object of the present invention is to provide an easy navigation to view information on protein-protein interaction, knockout, mutagenesis, catalyst, interaction site, etc.

Another object of the present invention is to provide information on all biological entities in the pathway and represent them in the form of either a pathway diagram or report.

Yet another object of the present invention is to display the nature of interactions between two biological entities (mechanism, mode, relation and direction) in a pathway diagram.

Further another object of the present invention is to display information on the expression profiles of the responsive genes.

Another object of the present invention is to generate customized reports on genes and their interactions.

Yet object of the present invention is to provide dynamic generation of pathway diagrams with highlighting based on expression level.

Still another object of the present invention is prioritising the pathways/disease/physiology based on the number of gene hits in a pathway/disease/physiology in a microarray search.

Further object of the present invention is the ability to port the pathway information in XML, SBML, Resnet, etc. file formats for interoperability of data across platforms.

### SUMMARY OF THE INVENTION

A computer system for analysis and visualization of signalling and metabolic pathways, said system comprising a plurality of functionally inter-related databases including data warehouse for extracting at least one attribute of a biological entity, a pathway database for storing curated signalling interaction, component and micro-array data of the biological entities, said plurality of databases including a processed database, said processed database further comprising a hierarchical arrangement of signalling interactions among the biological entities, components and micro-array data, a curator member to generate curated signalling interaction between the biological entities obtained from external sources, a processing system including a server module to fetch and/or generate desired dynamic pathways from the stored signalling interactions, components or micro-array data, said processing system to obtain information on the selected biological entities or their interactions from said dynamic pathways, a user interface for creating, querying, and viewing the dynamic pathways. The present invention also provides a method for pathway and component search and microarray analysis and visualization of signalling and metabolic pathways of biological entities.

### BRIEF DESCRIPTION OF THE ACCOMPANIED DIAGRAMS

The patent or application file contains at least one drawing executed in color. Copies of this patent or patent application publication with color drawing(s) will be provided by the Office upon request and payment of the necessary fee.

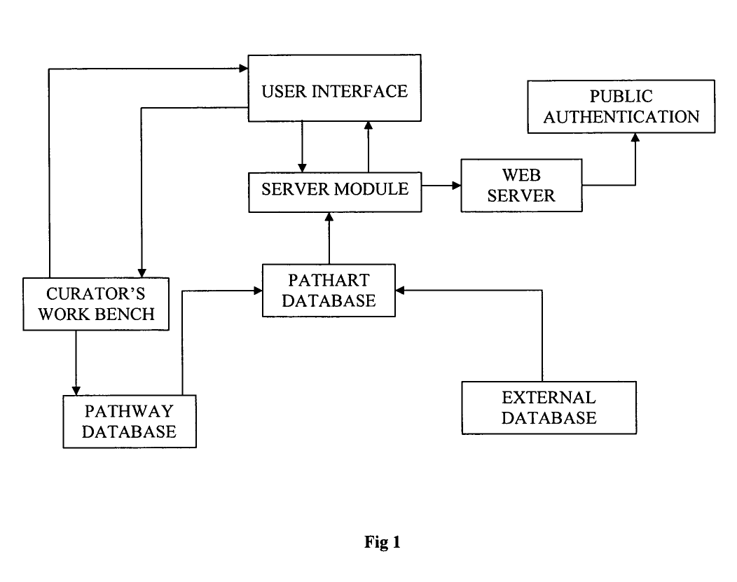

FIG. 1 is schematic representation of the system of the present invention.

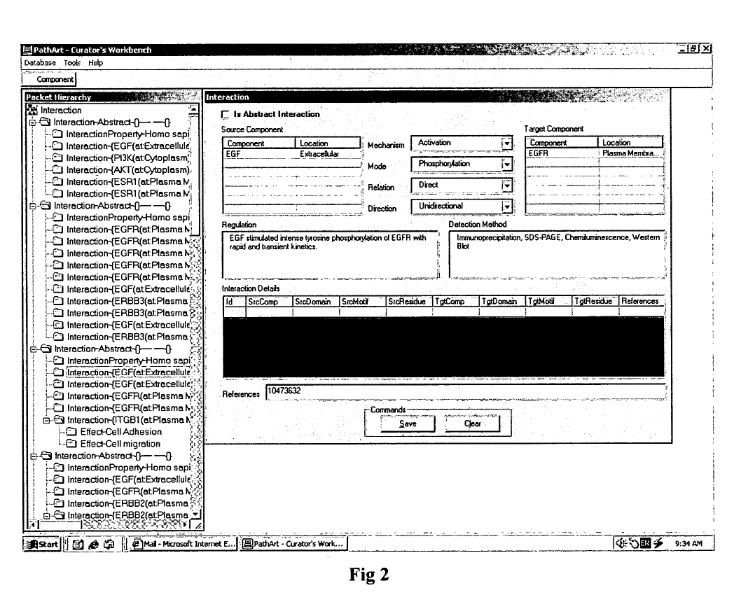

FIG. 2 depicts EGF Signaling Pathway in Breast Cancer entered with Curator member of the present invention.

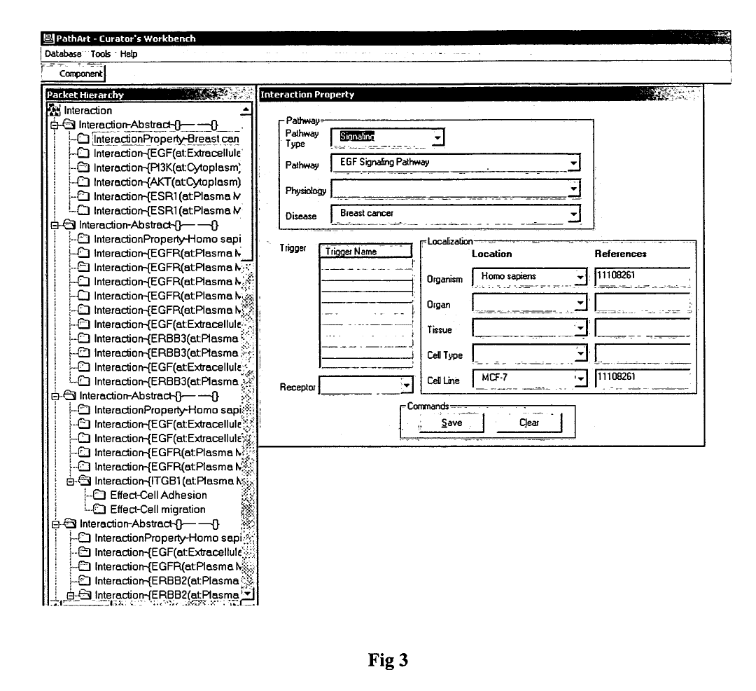

FIG. 3 depicts inheritance of the properties by a child interaction with parent.

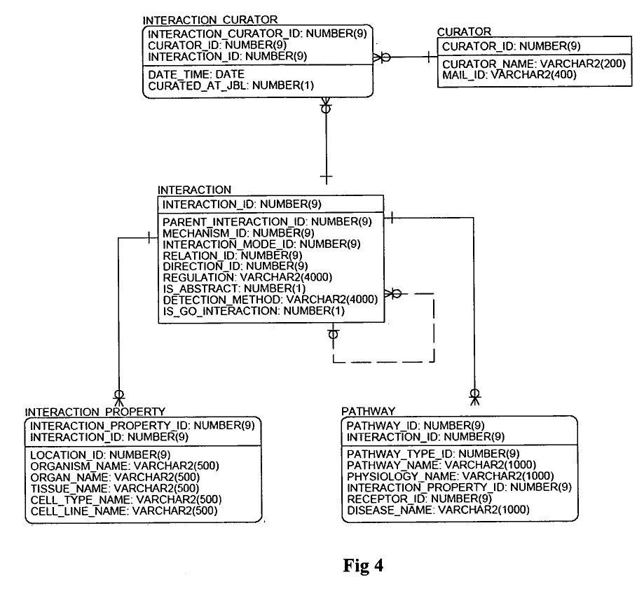

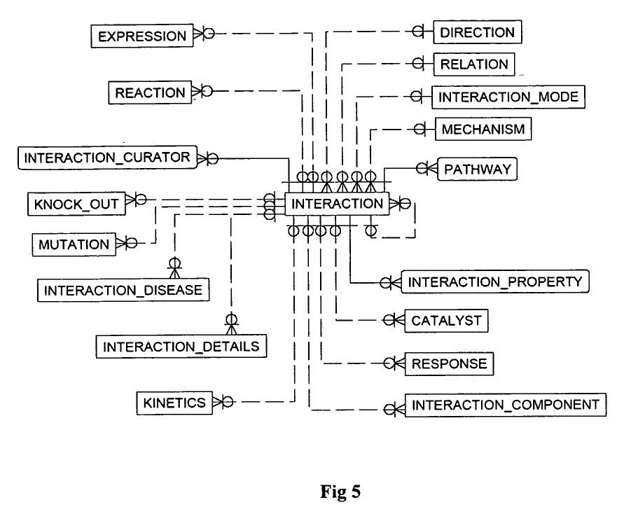

FIG. 4 depicts a schema of pathway entry.

FIG. 5 depicts a schema of pathway interaction and related tables.

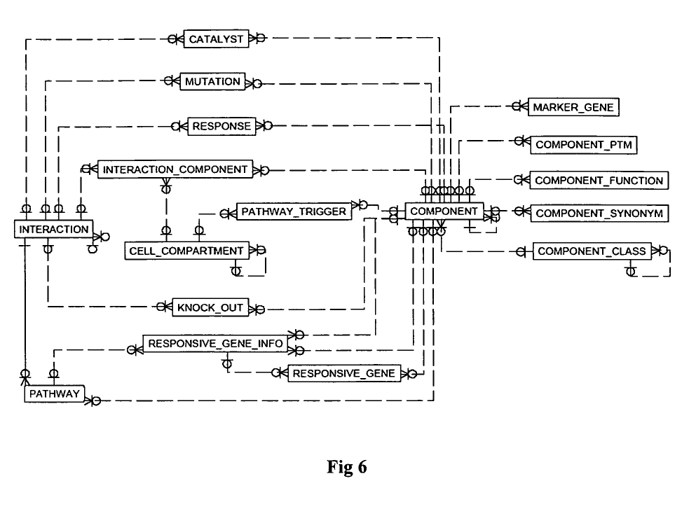

FIG. 6 depicts a schema of relationship between interaction and component.

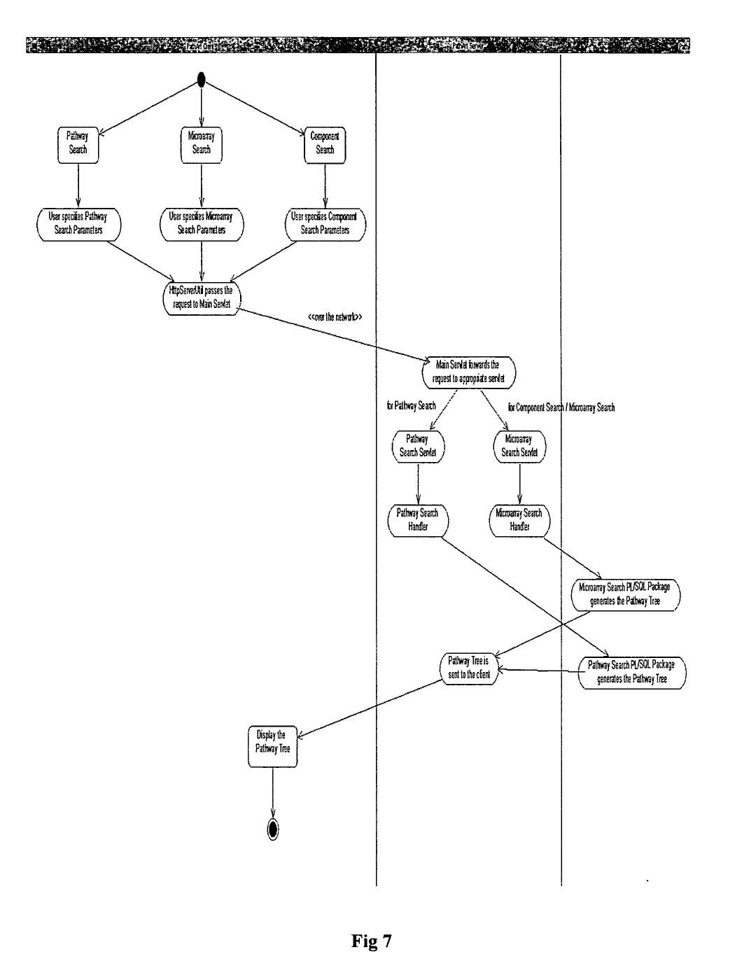

FIG. 7 depicts a flow diagram for Pathway, Component and Microarray Search.

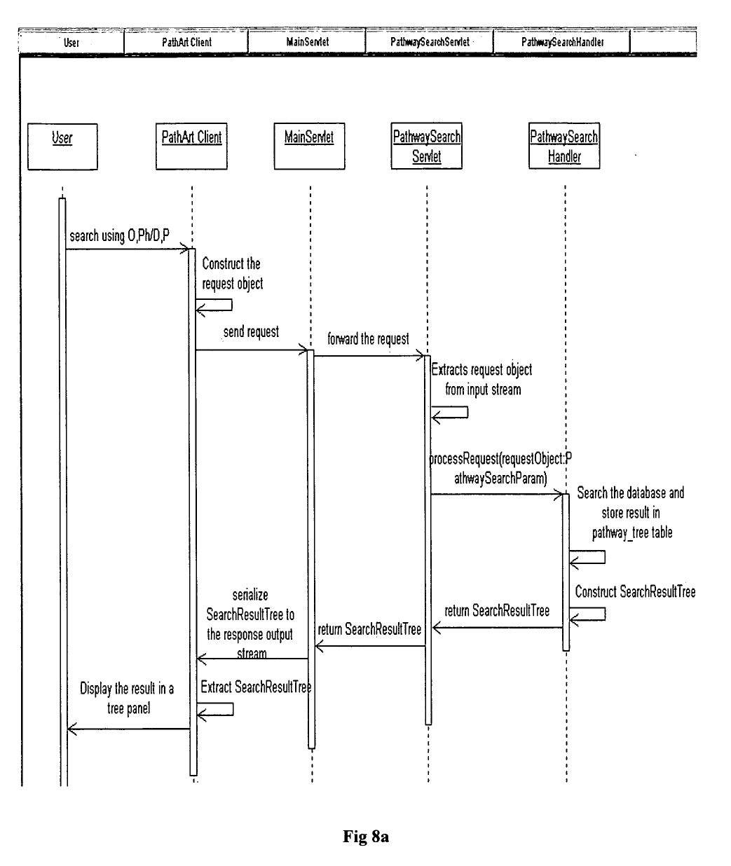

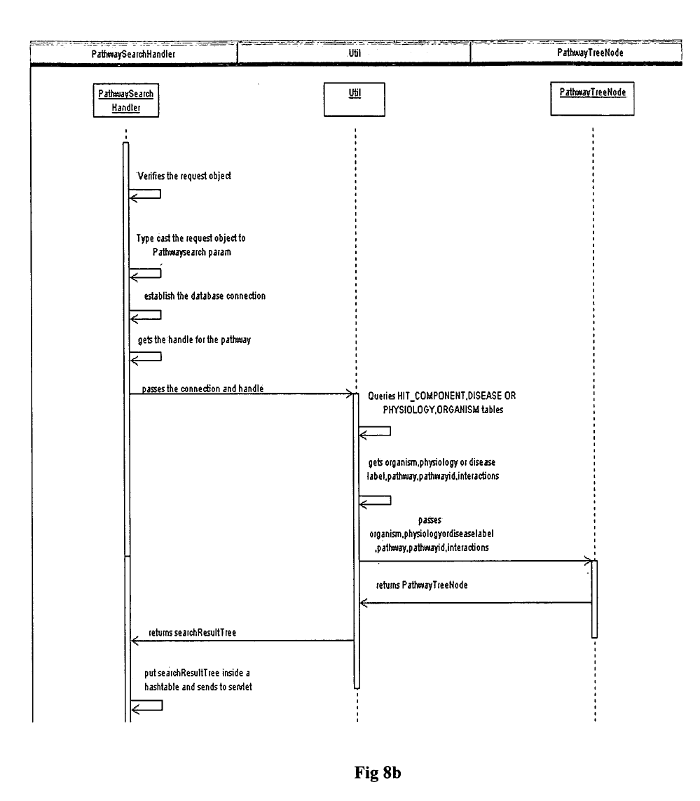

FIG. 8a & b depict for the Sequence Diagram of the Pathway search.

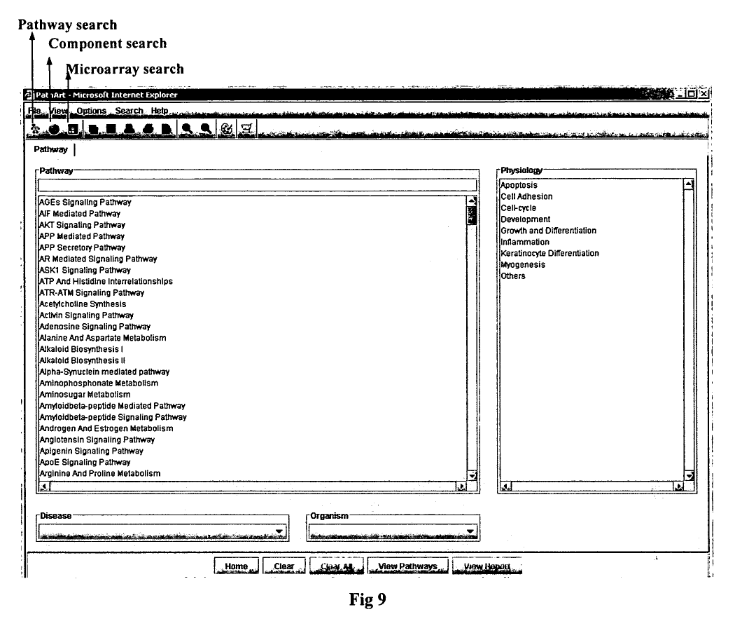

FIG. 9 depicts a user interface for Pathway Search.

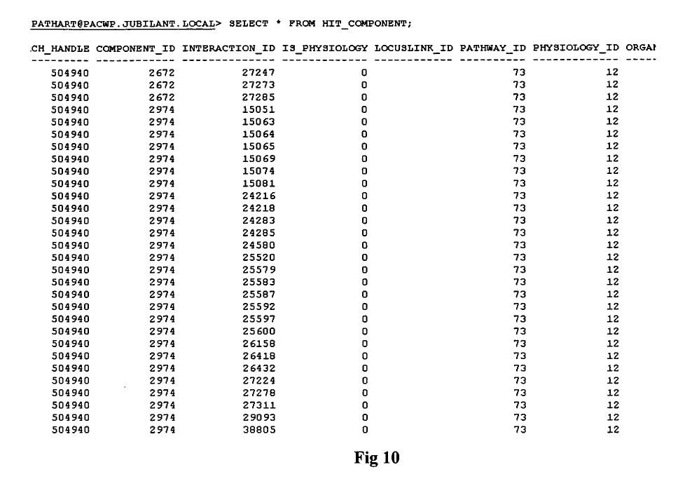

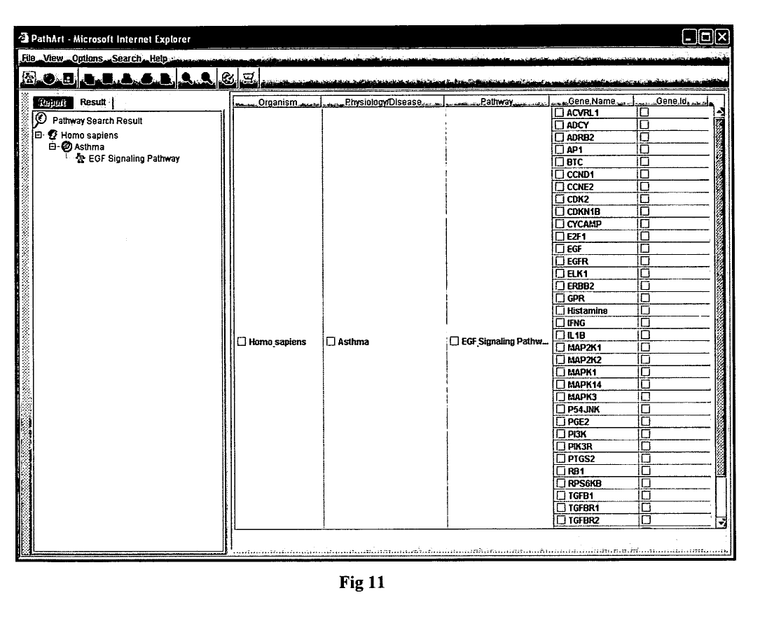

FIG. 10 depicts sample data set of a temporary table in Pathway search.

FIG. 11 depicts the results of Pathway Search.

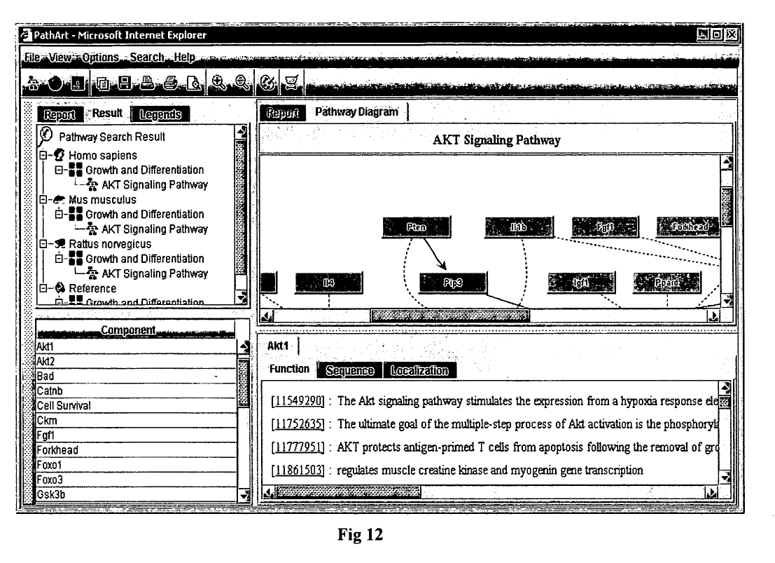

FIG. 12 depicts components, component information and interaction map.

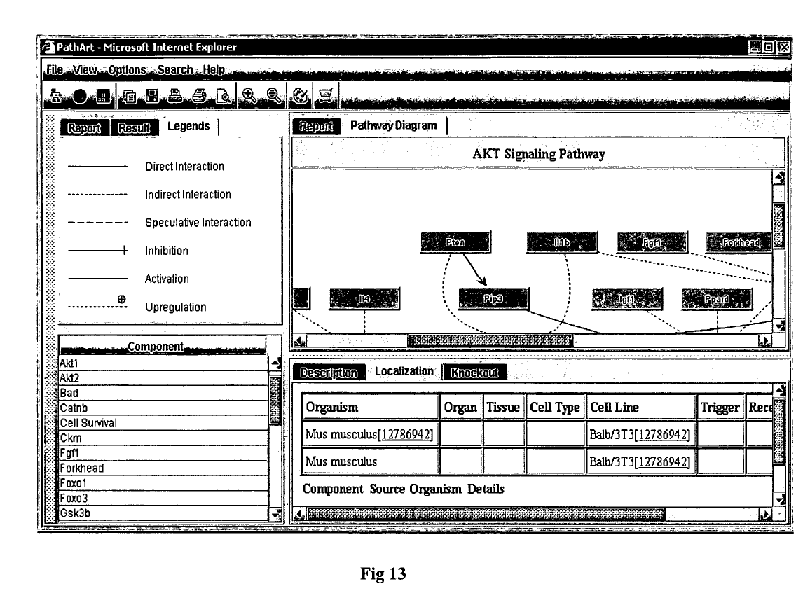

FIG. 13 depicts components, regulatory information and interaction map.

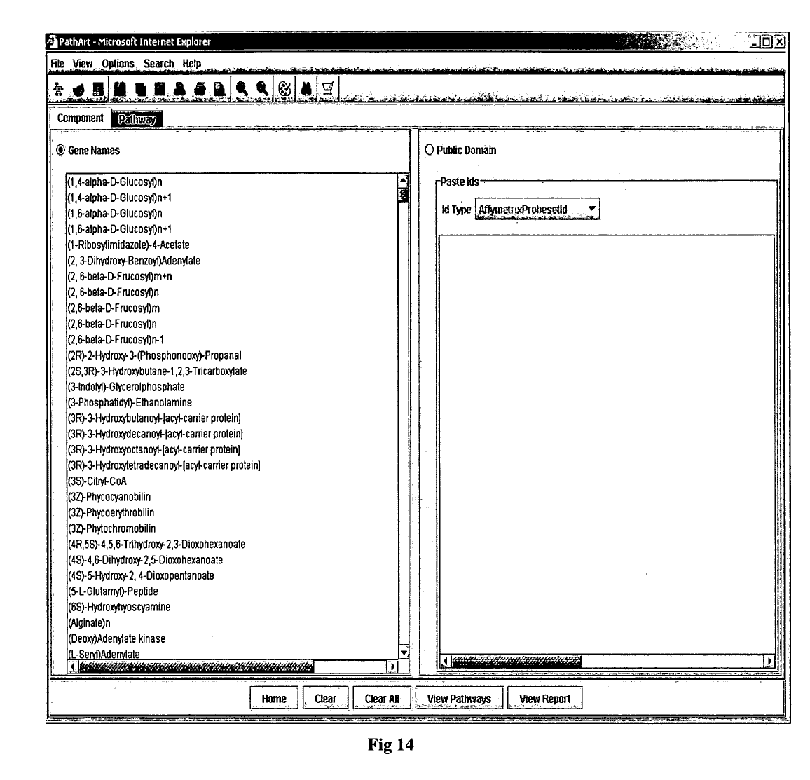

FIG. 14 depicts a user interface for Component Search.

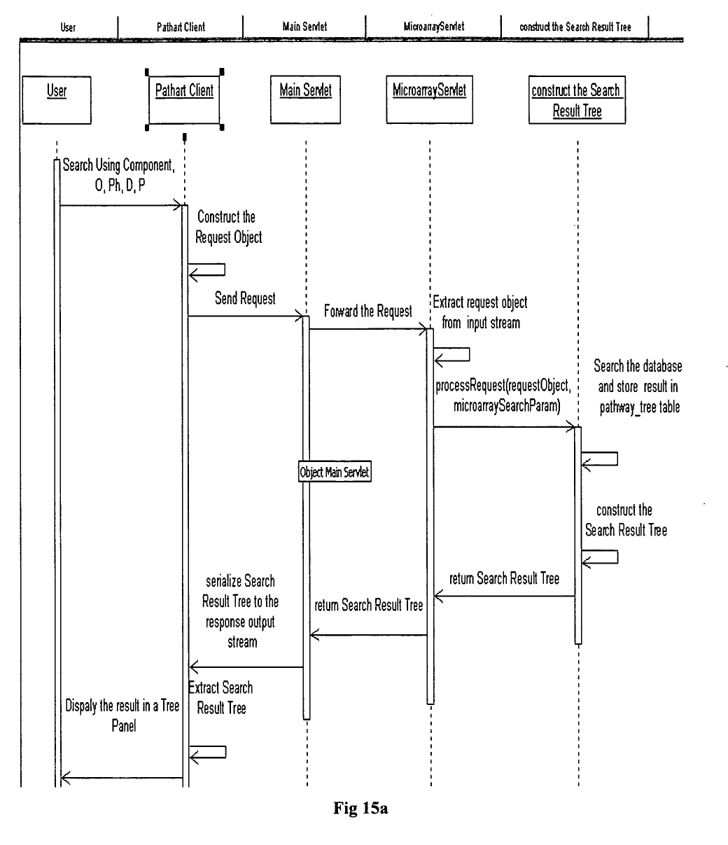

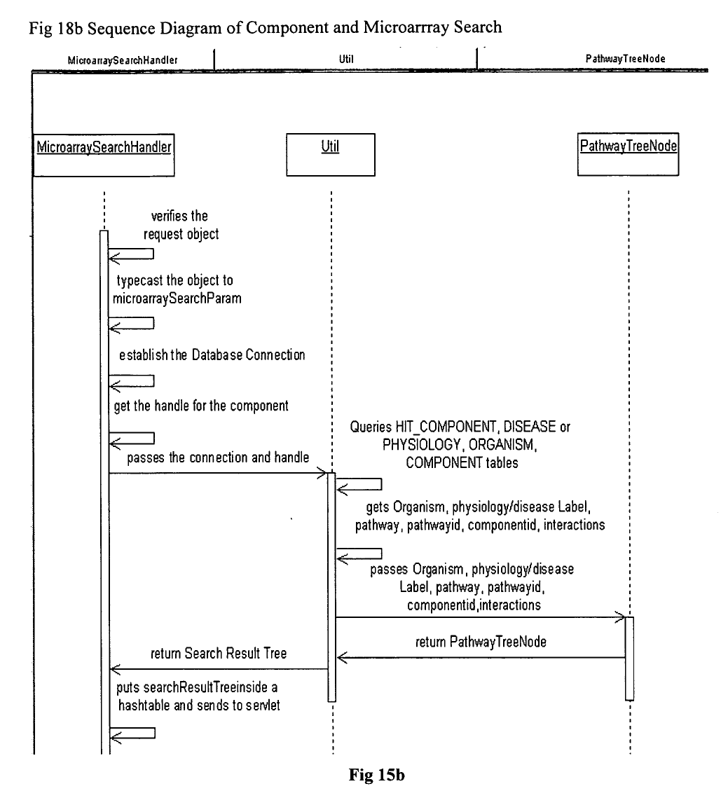

FIG. 15a & b depict Sequence Diagram of the Component and Microarray search.

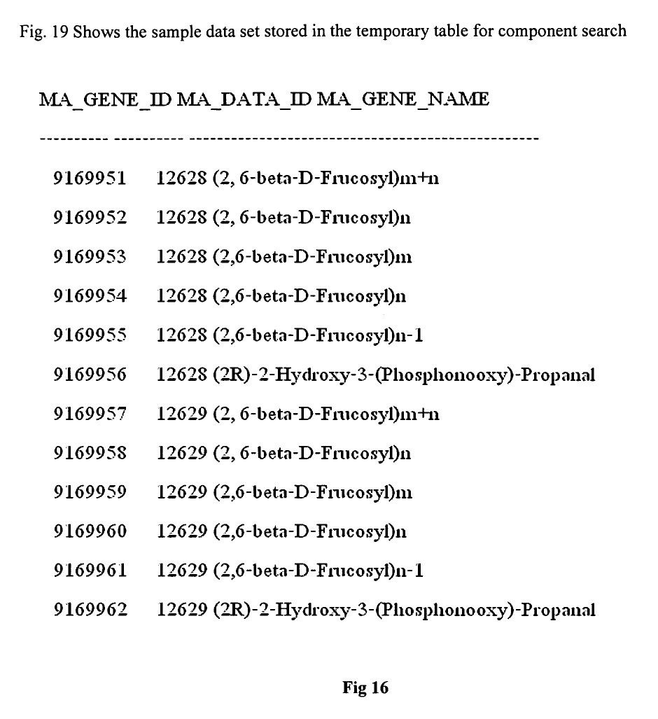

FIG. 16 depicts sample data set stored in the temporary table for component search.

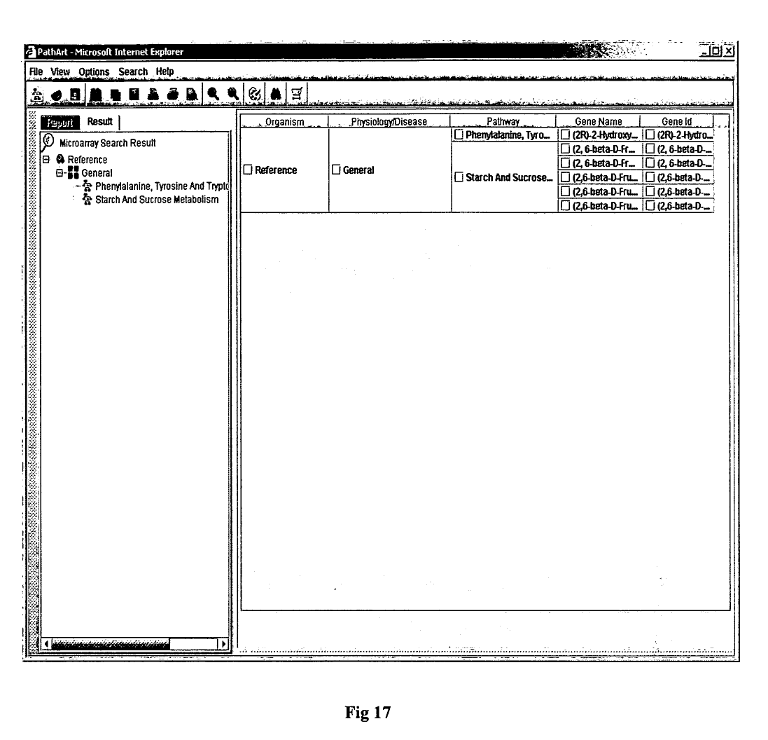

FIG. 17 depicts results of Component Search.

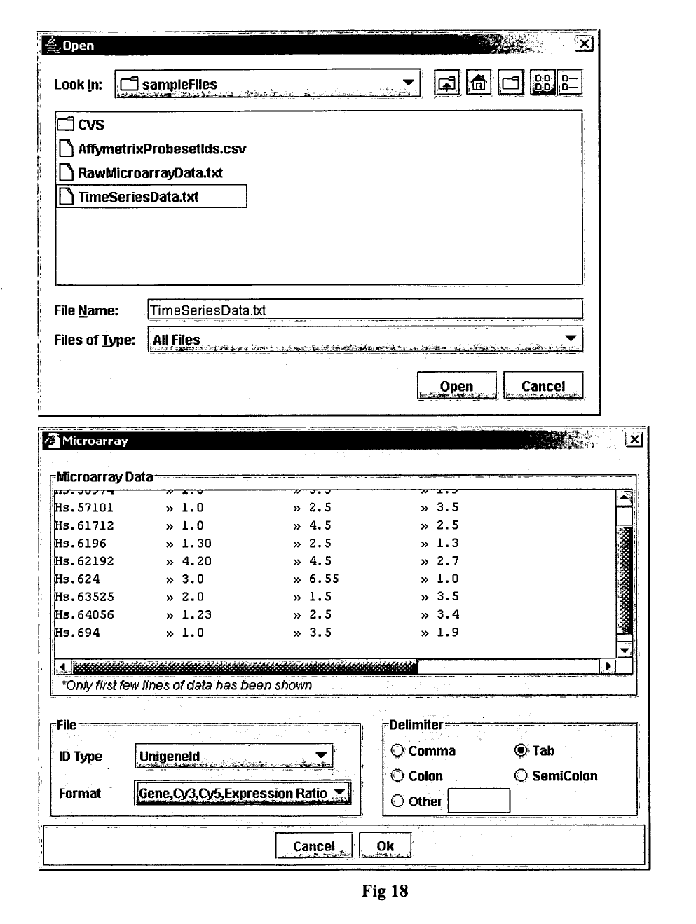

FIG. 18 depicts microarray data upload.

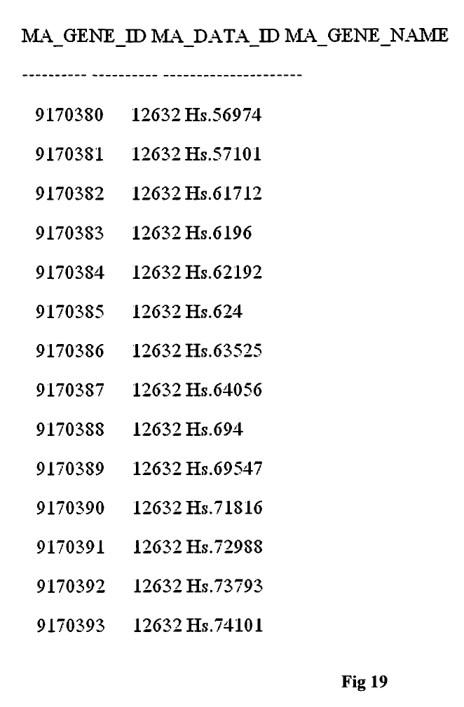

FIG. 19 depicts sample data set stored in the temporary table for microarray search.

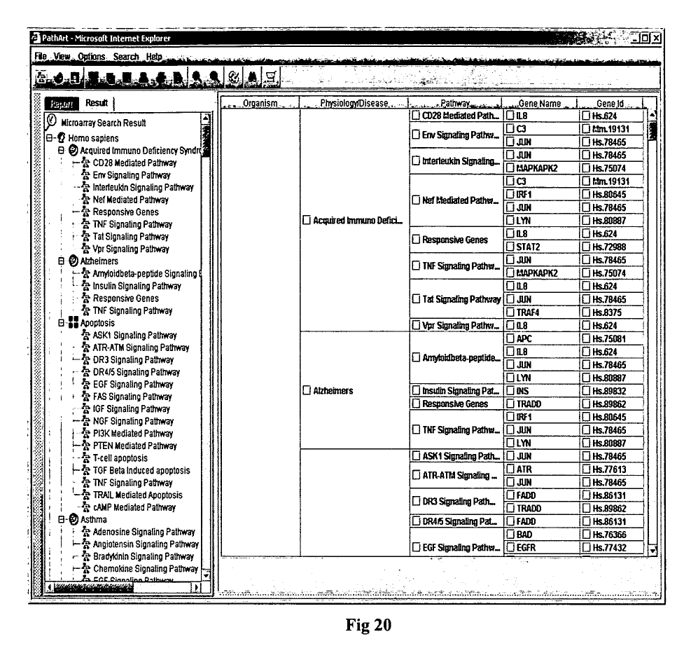

FIG. 20 depicts the results of microarray search

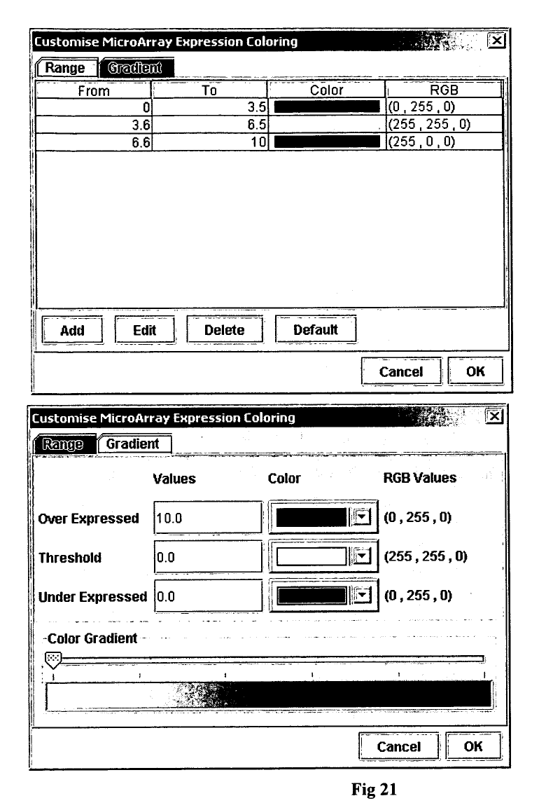

FIG. 21 depicts the utility of changing the colour threshold of the system of the present invention.

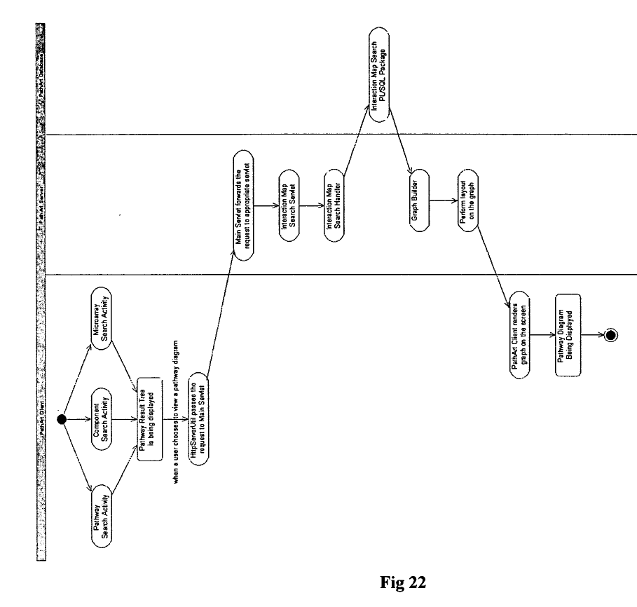

FIG. 22 depicts flow diagram of Graph Builder.

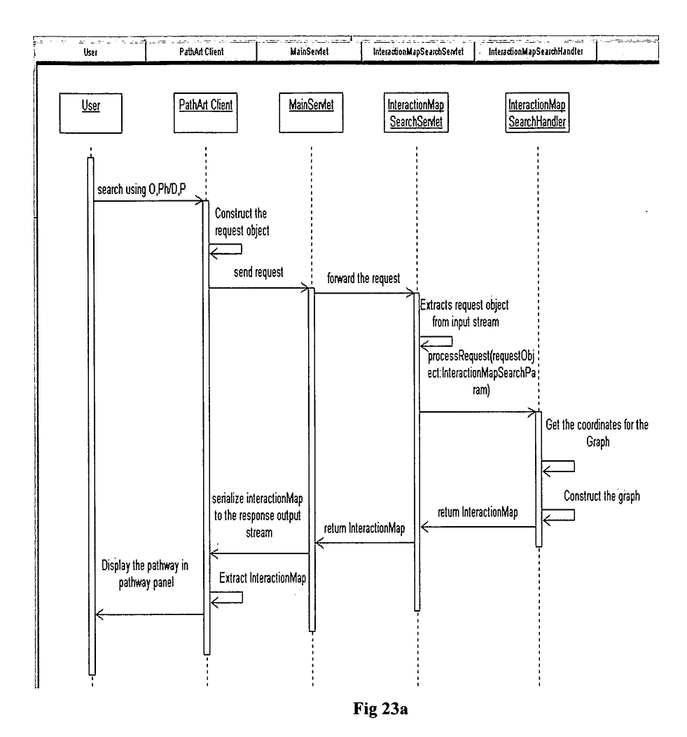

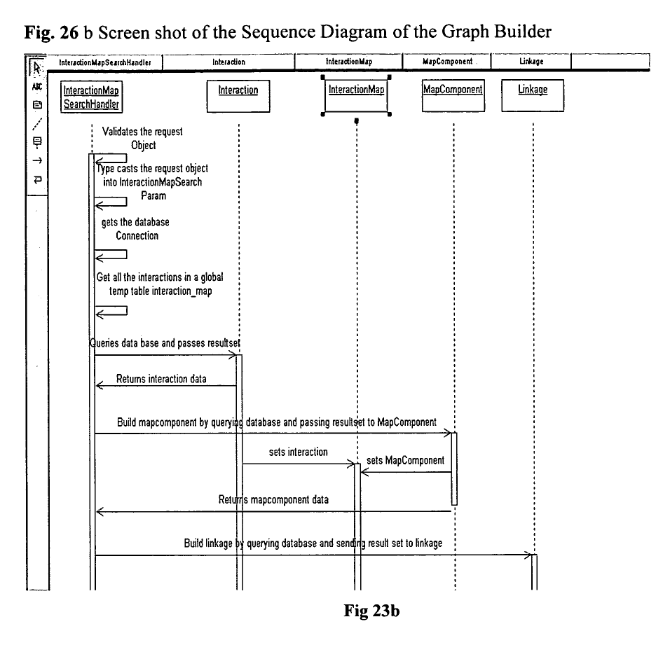

FIG. 23a & b depicts Sequence Diagram of the Graph Builder.

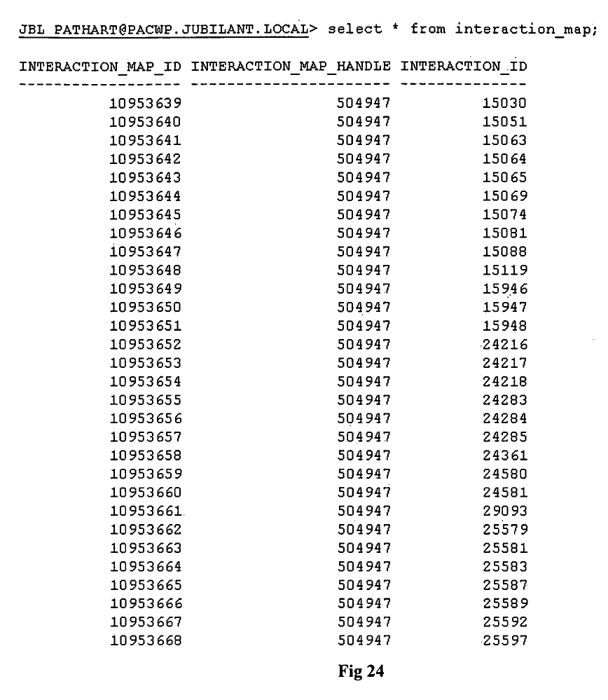

FIG. 24 depicts a snap-shot of sample data set stored in the temporary table for graph builder.

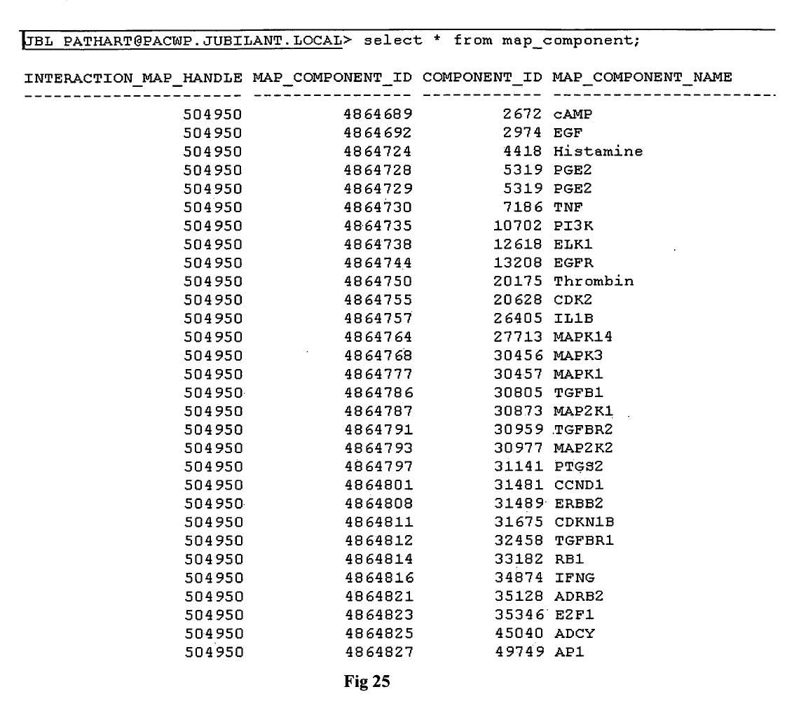

FIG. 25 depicts a temporary table with relationships between components and interactions.

### DETAILED DESCRIPTION OF THE INVENTION

Definitions

A “biological entity”, which is a particular or discrete unit that is a part of, plays role in, or affects a biological system. Biological entities include components of a biological system or objects, elements or molecules that affect biological functions.

An “interaction” defines the nature by which two or more proteins or bio-molecules are related to each other in a signaling or metabolic network, linked by directional arrows.

A “pathway diagram” is a graphical representation of relationships between and among biological entities or compositions of biological entities, involved in a biochemical cascade stimulated by a trigger or condition in a disease or physiological process.

A “component” is a gene, protein or any other bio-molecule participating in an interaction.

An “interaction map” also is a graphical representation of relationships between and among biological entities or compositions of biological entities, linked to each other irrespective of their involvement in a biochemical cascade, but due to their nature to interact with one another.

A “gene” is a fundamental physical and functional unit of heredity. A gene is an ordered sequence of nucleotides located in a particular position on a particular chromosome that encodes a specific functional product (i.e., a protein or RNA molecule).

A “protein” is a polymer of amino acids linked via peptide bonds and which may be composed of two or more chains. The uniqueness of individual proteins depends on the length and order of amino acids within the proteins.

A “hit” refers to a result—a component, interaction or a pathway that matches the user query.

“Data” refer to the information gathered from literatures and public domain databases relating to the biological entities.

“Upregulation” refers to a positive regulatory effect on physiological processes at the molecular, cellular or systemic level.

“Downregulation” refers to a negative regulatory effect on physiological processes at the molecular, cellular or systemic level.

“Micro-array” refers to an array of DNA or protein samples that can be hybridized with probes to study patterns of gene expression.

“Dataset” is a collection of data records having values obtained by performing Micro-array experiments.

“Time series data” refers to data obtained by measurement of gene expression amounts of a subject of group of genes over the course of time.

### DESCRIPTION OF THE INVENTION

The present invention relates to a digitally-implemented computer system for storing, modifying, retrieving, analyzing and visualizing biological data of biological entities.

Referring to FIG. 1, wherein the system of the present invention is shown. The system of the present invention comprises a plurality of inter-related databases, a processing system having a server module and a user interface for analysis and visualization of signaling and metabolic pathways.

The data storage means of the present invention comprises, an external database, a pathway database and a pathart database, said databases are functionally linked to one another to facilitate transfer of data.

The external database which is designated as jbl_pddb schema is an integrated platform for data from more than 13 external data sources. The external data sources are public domain databases having data pertaining to functional annotation of human, mouse and rat genes. The public domain databases include UniGene, LocusLink, HomoloGene, Genbank, Affymetrix, Agilent, and Applied Biosystems & Amersham Biosciences. The data from public domain databases are imported into data ware house or jbl_pddb. The sequence, function, localization and summary data obtained from public domain databases such as GO, OMIM, Pubmed, InterPro, EC, TrEMBL/SWISS-PROT and KEGG Pathway databases can also be made available to the present system by way of hyperlinks, subject to prior permission, wherever necessary, obtained from the respective owners of such sources.

The data storage means also comprises a pathway database, which is designated as jbl_pathway schema. The pathway database is a knowledge base comprising interactions between biological entities. The data of said pathway database are acquired through a data capture application means designated as curator member or curator's workbench (CWB).

The application of curator's workbench (CWB) is depicted in FIG. 2-4. The interactions between the biological entities are organized in a hierarchical manner to ease the data acquisition process. They are stored as a hierarchy of interactions where child interactions inherit properties from parent interactions. The interaction property parameters are Organism, Organ, Tissue, Cell Type, Cell Line, Disease, Physiology, Pathway, Trigger and Receptor.

The set of interactions, which belong to a specific interaction property, is organized under one abstract interaction. The abstract interaction is an interaction, which doesn't contain any data; but has interaction properties only to be inherited by child interactions. If there are multiple parents with interaction properties, all the interaction property tuples are considered. The child interaction also can have interaction properties. Usually organism, physiology, disease, pathway, trigger, receptor, and organ, are specified in the parent abstract interaction whereas tissue, cell type, and cell line are specified in the specific child interactions. An interaction may involve one or more components. It comprises at least one source component and a target component. It may optionally have other information pertaining to the interaction like expression, kinetics, effect, catalysts, mutation, knock out, etc. (FIG. 5). Components interact with other components either in-vivo or in-vitro. Some of these interactions are deciphered or documented as a part of some pathways, or physiologies, or diseases.

A component participating in an interaction may be in a specific cellular location and state. The cellular location may be Nuclear Membrane, Cytoplasm, Plasma Membrane, Mitochondria, etc. The component state tells whether the component is bound to other components or phosphorylated. (FIG. 6).

For example, if a component A participates in the interaction only when it is bound to B and C, which in turn is bound to D. In the notation it is written as [bound:B,C(bound:D)].

Interaction Notation: It shows the components participating in the interaction, their location and state. It also shows the mechanism and mode by which the source components are regulating target components. It also shows the direction of interaction and relation, which tells whether the interaction is direct, indirect, or speculative.

<At> : “at”
<Colon> : “:”
<OpeningBrace> : “{”
<ClosingBrace> : “}”
<OpeningBracket> : “(”
<ClosingBracket> : “)”
<OpeningSquareBracket> : “[”
<ClosingSquareBracket> : “]”
<3 Dash> : “---”
<ComponentInfo> ::= <OpeningBrace> <OpeningBracket>
<Component> <Localization> <OpeningSquareBracket>
<ComponentState> <ClosingSquareBracket>
<ClosingBracket> <ClosingBrace>
<ComponentInfo> ::= <OpeningBrace> <OpeningBracket>
<Component> <Localization> <ClosingBracket>
<ClosingBrace>
<Localization> ::= <OpeningBracket> <At> <Colon>
<CellCompartment> <ClosingBracket>
<InteractionText> ::= <ComponentInfo>
<InteractionDetails> <ComponentInfo>
<InteractionDetails> ::= <LeftDirectionIndicator> <3
Dash> <InteractionMechanism> <OpeningSquareBracket>
<InteractionMode> <ClosingSquareBracket> <3 Dash>
<RightDirectionIndicator>
<InteractionDetails> ::= <LeftDirectionIndicator> <3
Dash> <InteractionMechanism> <3 Dash>
<RightDirectionIndicator>
{A{at:Cytoplasm)[bound:B,C(bound:D)]}---Upregulates
[Phosphorylation]---
>{E(at:Cytoplasm)[bound:F(bound:H),G(bound:H)]}

Source component: A, at cytoplasm, which is bound to B and C, which in turn is bound to D.

Directly upregulates the target component via phosphorylation.

Target component: E, at cytoplasm, which is bound to F, which in turn is bound to H and G, which in turn is bound to H.

For instance, the canonical Wnt Signaling pathway is highly conserved between Drosophila, Xenopus and vertebrates. In the absence of a Wnt signal, active GSK3 is present in a multi-protein complex that targets beta-catenin for degradation via ubiquitin-mediated degradation. The phosphorylation of beta-catenin by Glycogen synthase kinase-3 (GSK3) at a series of N-terminal serine residues is greatly enhanced by the presence of Axin, which acts as a scaffold by binding to several components of the complex, including Glycogen synthase kinase-3 (GSK3) and the product of the adenomatous polyposis coli (APC) gene.

This information is represented as
{GSK3(at:cytoplasm)[bound:AXN(bound:APC)]}—Regulates[Phosphorylation]—→{CTNNB 1 (at:cytoplasm)}
   where AXN is Axin gene and CTNNB 1- beta catenin.

The Pathway curation approach for elucidating the molecular networks include identification or selection of a disease one is interested in. Study the etiology as well as the pathophysiology of the disease from published reviews. Study the normal physiological pathway in the target tissues and the affected physiology of the target tissues. Select the mediators that are known to influence the normal physiology of the target tissues by going through peer reviews. Shortlist a set of keywords for searching published papers. Find keywords related to selected mediators for pathway building in relevance to the particular disease and critical components in the pathway to screen relevant papers.

To select the most relevant papers, using the selected keywords search PubMed (www.ncbi.nlm.nih.gov/PubMed), other relevant online journal sites and search engines to search the titles and abstracts for identifying protein-protein interactions in a patients/diseased tissue/cell type. Select the sources that speak about some components of the normal pathway which are being modulated in some manner by the trigger so that it affects the normal signalling and leading to a condition that ultimately leads to the disease. Organise all the papers on the basis of their cascade like triggers to receptors and receptor to other signalling components.

For instance, for Diabetes Type II, find the relevant patho-physioliological conditions associated with the disease like insulin resistance, obesity, hyperglycemia etc. The mediators influencing such conditions like Free Fatty Acid (FFA), Insulin, TNFalpha, etc. will be listed. All these will be used as key words to search the relevant literature in the literature databases like PubMed, Highwire, etc.

Data are entered into a data acquisition application, called the Curator's Workbench that organizes the entered data in a hierarchy to avoid redundant entries. Curator's Work Bench is used for entering pathway information or updating the existing pathway information as per the current scientific understanding of an interaction. The interactions are organized in a hierarchical fashion to ease the data acquisition process. From each scientific sources all the interactions covered in that source are manually read and extracted and entered interaction by interaction in the interaction form. For a particular interaction, details of protein-protein interaction (domains, motifs, residues, etc.,) are entered along with regulation details of the interaction. Any other details pertaining to the interaction such as mutation, knock out, kinetics, catalyst, expression data are entered in the respective forms. (FIG. 2) Curator's Workbench is used to enter interaction information into the jbl_pathway schema. Curator Workbench is a Windows based 2-tier application. It is developed using Microsoft Visual Basic 6. It uses ADO and Oracle OleDB driver to connect to the database. It has an Application Configuration Server, which provides information about the database configuration and application settings.

The interactions are entered in hierarchical manner to reduce data redundancy and to speed up the data acquisition process. The root interaction will be added as abstract interaction. This can be done by clicking is abstract check box. By adding an interaction property form under the abstract interaction form, one can enter the interaction properties such as pathway name, disease or physiology name and organism name which are common to all the child interactions. All the interaction forms for this specific pathway will be added under this interaction property form. Under each interaction form an interaction property form can be added to enter the properties like Organ, Tissue, Cell Type, Cell Line which are specific to one particular interaction. (FIG. 3) In interaction form the interaction between one biological entity(component) to another biological entity can be entered with information like Source component, Target Component, Mechanism, Mode, Relation, Direction, Regulation, Detection Method. By double clicking the component name in the interaction form we can open the interaction component form in which the information related to the component like component name, component state, location, description, SwissProt id, PDB Id, CAS Reg Id and PMID can be added.

In order to maintain the hierarchical relationship between the interactions in one specific pathway, interaction table comprises two columns termed as interaction id and parent interaction id. A child interaction contains the parent's interaction id in the parent interaction id column. All the PMIDs for interaction, effect, mutation, knock out are stored in a single table called reference. This table contains columns like reference id, table id, column id, reference data (PMID). This table enables the feasibility to have more than one PMID in single form. The functions loadReference and saveReference are used to store and retrieve the PMID.

Dimension Tables form enables the Administrator to add, modify and delete the dimension values for combo boxes. buildCombo function is used to populate the dimension values in combo boxes.

The third type of database, which is a pre-computed pathart database and designated as jbl_pathart schema, wherein all the gene names and protein names from jbl_pddb are stored into a table in jbl_pathart schema. In jbl_pathway schema, component names are mostly Locuslink official gene symbols. The jbl_pathart schema acts as a bridge between jbl_pathway and jbl_pddb external databases. jbl_pathart maintains the linkage by building a mapping between the official/alternate gene/protein symbols available in locuslink and unigene databases to gene/protein symbols stored in jbl_pathway.

The address locations of the data including pathway, physiology, disease, organism, interaction and component tables from jbl_pathway are mapped into jbl_pathart. The pathway database is updated and the corresponding changes are carried out in jbl_pathart as well.

Integration of all the above databases with the pathart database is performed done using data loaders (written in Java & JDBC using Oracle DB) and SQL file for creating relational tables.

The user interface of the system of the present invention provides means for creating, querying and viewing the processed data. The user interface is a web-based graphical visualization tool that analyzes the underlying database and dynamically builds a pathway schematic. The biological entities are displayed in a cell schematic or as a pathway diagram. The user interface also displays annotated information on different biological entities and interactions between them.

The pathway search performed by implementing the method of the present invention based on an Organism, Disease or Physiology, and Pathway. The Pathway search is the first screen on the PathArt application. It enables identification and comparison of pathways across physiologies, diseases, organisms using Pathway search. The pathway of choice can be selected from the proprietary list of pathway names displayed in the Pathway name list in combination with the physiology/disease and organism or combination thereof. (FIG. 7). The Pathart Client is the client UI using which an user can select the pathway for pathway search. HttpServerUtil is an inferface between Pathart client and Server. This is a java class and it is applied with façade pattern. MainServlet is a servlet and gives the entry point to Pathart Server. This Servlet receives the client request from HttpServerUtil and forwards to PathwaySearchHandler.

PathwaySearchServlet reads the request from input stream and writes the response to output stream. This class sends the read request to PathwaySearchHandler for further database operations.

PathwaySearchHandler is a java class designed with DAO pattern. This class establishes the connection with Pathart database and passes the search parameters and retrieves the result. This also constructs the result object and sends to PathwaySearchServlet.

Pathart Database is an oracle database where all the curated and PDDB data stored across tables. (FIG. 8a & b).

For instance, as an exemplary embodiment, searching Epidermal Growth Factor (EGF) Signaling Pathway in Asthma in Homo sapiens is shown. (FIG. 9) Selected pathway name is put inside a hash table (requesthash) along with searchType (‘Pathway Search’) and sent to HttpServerUtil class. The MainServlet receives the request and forwards to PathwaySearchServlet. The PathwaySearchServlet reads from the input stream and sends the request object to PathwaySearchHandler. The PathwaySearchHandler checks the validity of the request object and then type casts into PathwaySearchParam. Database connection is obtained through DBUtil class. Handle for ‘EGF Signaling Pathway’ is obtained by executing PathwaySearch procedure by passing the pathway name, disease, physiology as parameter. This procedure joins the component, pathway, physiology and organism tables and searches for ‘EGF Signaling Pathway’. It stores the results into a temporary table in jbl_pathart schema. (FIG. 10). Organism, physiology, disease and pathway names are obtained from interaction property and pathway tables. The PathwaySearchServlet writes the response object into output stream. The PathartHelper class reads the response object sent by servlet and sends to PathartApplet. The PathartApplet extracts the root nodes and child nodes and displays in tree panel. (FIG. 11).

The biomolecular signalling interactions are displayed as either dotted or solid lines, this information is also called as regulatory information. FIG. 12 displays components, regulatory information and interaction map. To obtain the information regarding the interactions between the biological entities, the desired interactions (arrows) on the pathway diagram is selected to view the available information on Interaction details, Mutation, Localization, Knockout, etc.

FIG. 13 depicts details of biomolecular interactions of the biological entities and information on the components can be generated. The report is generated by selecting the Pathway from the Pathways list, clicking on view pathways, clicking on the Physiology/Disease node or the corresponding pathway node, from Pathway Result, then clicking on the Report tab, and selecting the details to be viewed in the Report.

These details are the information curated from scientific literature and public domains databases. Finally the Generate Report processing bar will be displayed. The report generated is based on selected parameters.

In Component Search the proprietary list of components along with their pathways can be searched for. The search can be performed across pathways, physiologies/diseases, and organism. (FIG. 7).

Pathart Client is the client UI using which user can select the component(s), Pathways, Physiologies, Diseases, Organisms for Component Search. (FIG. 14) HttpServerUtil is an interface between Pathart client and Server. This is a java class and it is applied with façade pattern.

MainServlet is a servlet and gives the entry point to Pathart Server. This Servlet receives the client request from HttpServerUtil and forwards to MicroarraySearchHandler.

MicroarrayServlet reads the request from input stream and writes the response to output stream. This class sends the read request to MicroarraySearchHandler for further database operations.

MicroarraySearchHandler is a java class designed with DAO pattern. This class establishes the connection with Pathart database and passes the search parameters and retrieves the result. This also constructs the result object and sends to MicroarrayServlet.

Pathart Database is an Oracle database where all the curated and PDDB data stored across tables. (FIG. 15a & b).

User can select one or more components of choice from the Component Search feature. Selected Component name(s) is put inside a hashtable (requestHash) along with searchType (‘MicroarraySearch’) and sent to HttpServerUtil class. MainServlet receives the request and forwards to MicroarrayServlet. MicroarrayServlet reads from the input stream and sends the request object to MicroarraySearchHandler.

MicroarraySearchHandler checks the validity of the request object and then type casts into MicroarraySearchParam. Database connection is obtained through DBUtil class. Handle for selected components is obtained by executing PathwaySearch.getPathwaysForPathwaySearch procedure by passing the pathway name, disease, physiology as parameter. This procedure joins the component, pathway, physiology and organism tables and searches for selected components. It stores the results into a temporary table. (FIG. 16). From COMPONENT, PATHWAY, PHYSIOLOGY, ORGANISM tables organism, physiologyOrDiseaseLabel, physiologyOrDisease, pathway, pathwayid, interactions values are obtained. Root node values like organism name, physiologyOrDiseaseLabel are passed into constructor of PathwayTreeNode class.

Child nodes are added into root nodes by using addChildNode method of PathwayTreeNode class. Final Pathway tree is built in util class and it is sent to MicroarraySearchHandler. MicroarraySearchHandler puts the searchResultTree into a hashtable and constructs the response object. MicroarrayServlet writes the response object into output stream. PathartHelper class reads the response object sent by servlet and sends to PathartApplet. PathartApplet extracts the root nodes and child nodes and displays in tree panel. (FIG. 17).

In “Microarray search”, the user can upload a microarray data set (as shown in FIG. 18) to view the expression data and significance of that component in a pathway.

Microarray search requires the input data to be in delimited text file. The delimiter can be any valid character like comma, semi-colon, tab, hyphen, etc. The format of the file can be one of the following Time Series Data (Gene ID, Time1, Time2, . . . ), Raw Microarray Data (Gene ID, Cy3, Cy5), Raw Microarray Data (Gene ID, Cy3, Cy5, Expression Ratio), Single Point Microarray Data (Gene ID, Expression Ratio).

The Gene ID can be Locuslink ID, Affymetrix Probeset ID, Amersham Probeset ID, Applied Biosystems Probe ID, Genbank Accession Number, Gene Name, Gene Symbol, etc. (FIG. 7).

In Microarray Search user selects a file from the Microarray Search feature. Selected File content is put inside a hashtable (requestHash) along with searchType (‘MicroarraySearch’) and sent to HttpServerUtil class. MainServlet receives the request and forwards to MicroarrayServlet. MicroarrayServlet reads from the input stream and sends the request object to MicroarraySearchHandler.

MicroarraySearchHandler checks the validity of the request object and then type casts into MicroarraySearchParam. Database connection is obtained through DBUtil class.

Handle for selected components is obtained by executing PathwaySearch.getPathwaysForPathwaySearch procedure by passing the pathway name, disease, physiology as parameter. This procedure joins the component, pathway, physiology and organism tables and searches for selected components. It stores the results into temporary table. (FIG. 19).

From COMPONENT, PATHWAY, PHYSIOLOGY, ORGANISM tables organism, physiologyOrDiseaseLabel, physiologyOrDisease, pathway, pathwayid, interactions values are obtained. Root node values like organism name, physiologyOrDiseaseLabel are passed into constructor of PathwayTreeNode class. Child nodes are added into root nodes by using addChildNode method of PathwayTreeNode class. Final Pathway tree is built in util class and it is sent to MicroarraySearchHandler. MicroarraySearchHandler puts the searchResultTree into a hashtable and constructs the response object. MicroarrayServlet writes the response object into output stream. PathartHelper class reads the response object sent by servlet and sends to PathartApplet. PathartApplet extracts the root nodes and child nodes and displays in tree panel. (FIG. 20).

### Summary of the Result

The results of micro-array analysis are depicted in the form of a summary sheet. The summary sheet as shown in FIG. 20 can be saved and printed. The pathway diagram can also be displayed. The genes hit from among the uploaded list will be colored based on the value and the default threshold value set to define the colors. To customize the colors of the components, to look for the values of other data points or time series choose the appropriate time point from the Condition drop down. The color map of the diagram changes according to the conditional value. The data values for genes in the Component list will change according to the selected conditional value.

The components derived from the micro-array data are displayed in a pathway diagram. These components are differentially colour-coded, based on their level of expression. Colour-coding of the molecules is based on expression ratios. The default colour settings are as follows: Genes with expression ratio above 2 fold (up regulated) are coloured red, Genes with expression ratio in the range of 1 and 0 (down regulated) are coloured green, Genes with expression ratio in the range 1 to 2 (unchanged) are coloured yellow. The colour threshold can be customized according to requirements of the user. The colour gradient can also be changed to suit requirement of the user. (FIG. 21).

Normalization of Micro-Array Data

Normalization helps to remove systematic variation in microarray experiments, which affect the gene expression levels. Normalization is done for a raw microarray data, which has Cy3 and Cy5 values for a set of Gene ID's for single time point or condition. The format of the uploaded dataset determines if normalization is possible or not. For data that cannot be normalized, the Normalizer tab is deactivated.

Clustering of Micro-Array Data

Clustering of data is essential for identifying biologically relevant groups of genes. Clustering helps in grouping genes, with similar expression profiles, especially in analysis of large scale gene expression data. The format of the uploaded dataset determines if clustering is possible or not. The clustering of Microarray data is mainly applied for time-series data. The selected gene set can be clustered using various metrics and linkages. For data that cannot be clustered, the Cluster tab is deactivated.

Gene Report

The Gene Report displays information on the Summary, Sequence, Affymetrix probeset data, Function, localization and the pathway. Appropriate links to the pubmed citation are also given. If no Gene ID is selected, the available information for all the genes is displayed in the Gene Report.

### Example for Micro-Array Data Analysis

The data set consists of the expression patterns of different cell types of colon tissue. Gene expression in 40 tumor and 22 normal colon tissue samples was analyzed with an Affymetrix oligonucleotide array (Affymetrix Hum600 array) complementary to more than 6,500 human genes.

The types of analysis that can be done in PathArt are
1. Directly link gene expression data with the pathway information: The experimental values for both the normal and the tumor cell lines were mapped on to “Colon Cancer”. The different pathways that showed substantial number of gene mapping were “Ceramide Signaling Pathway, EGF Signaling Pathway, FAS Signaling Pathway, Gastrin Signaling Pathway, HGF Signaling Pathway, IFNgamma Signaling Pathway, IGF1 Signaling Pathway, IL13 Signaling Pathway, IL1B Signaling Pathway, IL4 Signaling Pathway, Integrin Mediated Pathway, PAR Mediated Pathway, PGE2 Mediated Pathway, PKC Mediated Pathway, PPAR-gamma Signaling Pathway, PTEN Mediated Pathway, Ras Signaling Pathway, TGFbeta Signaling Pathway, TNF Signaling Pathway, TRAIL Signaling Pathway, UPAR Mediated Pathway, VEGF Mediated Pathway, VitaminD3 Signaling Pathway, WNT Signaling Pathway and p53 Signaling Pathway”.
2. Comparison of the behaviour of genes in normal and tumor tissues: In each of the pathways mentioned above, the differences in gene expression levels were compared in normal and tumor tissues. More than 159 genes (Table 1) showed differential expression in their values across the normal and the tumor types that were a part of a signalling cascade in Colon Cancer. The “Condition” drop down enables the user to view the behaviour of genes in tumor and normal coditions, while the colour threshold of choice for the expression data can be set using the “Customise Colour” icon.
3. To find the crosstalks where in a subset of the genes would also be involved in other physiologies—when the expression data was mapped, the subset of the genes that mapped to Colon Cancer also mapped on to “Apoptosis”, “Cell Cylce” and “Growth and Differentiation” Pathways. The intersection of the genes between Colon Cancer and Apoptosis were 47 (Table 2), which shows that there is a cross talk between these pathways.
4. To find coregulated families of genes: the k-means clustering of the data after z-score normalization showed that the coregulated families of genes clustered together, as demonstrated for the ribosomal proteins. Similar results were obtained using a two-way clustering method in the reference cited above.

5. Clustering based on GO biological process/cellular localization/molecular function: the expression data was also clustered using cellular process such as “cell cycle”. Around 83 genes were clustered, of which 24 genes were common to “Colon Cancer” and “Cell Cycle” Pathways.

TABLE 1
Gene list mapped to Colon Cancer

```
  1. ABCB1
  2. AKT1
  3. ALPI
  4. APC
  5. AREG
  6. ATF2
  7. BAK1
  8. BCL2
  9. BCL2L1
  10. BECN1
  11. BIRC4
  12. BMP4
  13. BMP6
  14. CA2
  15. CASP1
  16. CASP3
  17. CCKBR
  18. CCL5
  19. CCND1
  20. CD44
  21. CDC25A
  22. CDH1
  23. CDK2
  24. CDK6
  25. CDKN1A
  26. CDKN2A
  27. CEACAM1
  28. CEACAM5
  29. CEACAM6
  30. CHRM3
  31. CKS2
  32. CREB1
  33. CSK
  34. CTNNB1
  35. CXCL1
  36. CYCS
  37. CYP3A4
  38. CYP3A5
  39. CYP3A7
  40. DPEP1
  41. DUSP1
  42. EDN1
  43. EDNRA
  44. EDNRB
  45. EGF
  46. EGFR
  47. F2R
  48. F2RL1
  49. FADD
  50. FER
  51. FN1
  52. FOSL1
  53. FRAP1
  54. FZD2
  55. GAS
  56. GSK3A
  57. GUCA2A
  58. HGF
  59. HIF1A
  60. PRSS1
  61. PTGER1
  62. PTGER2
  63. PTGER4
  64. PTGS2
  65. PTK2
  66. PTPN13
  67. PTPRM
  68. PXN
  69. RAF1
  70. REG1A
  71. RELA
  72. RIPK1
  73. SELE
  74. SERPINE1
  75. SHC1
  76. SIAT1
  77. SLC26A3
  78. SMPD1
  79. SP1
  80. SP3
  81. SPARCL1
  82. STAT6
  83. TCF1
  84. TCF4
  85. TFAP2A
  86. TGFA
  87. TGFB1
  88. TGFB2
  89. TGFB3
  90. TGFBR1
  91. TGFBR2
  92. TGFBR3
  93. THBS2
  94. TIMP1
  95. TJP2
  96. TNA
  97. TNF
  98. TNFRSF1A
  99. TNFRSF6
100. TNFSF6
101. TP53
102. TRADD
103. VCL
104. VDR
105. VEGF
106. VIL1
107. WNT2
108. WNT5A
109. WT1
```

TABLE 2
List of genes common in Colon Cancer and Apoptosis

```
  1. AKT1
  2. ATF2
  3. BAK1
  4. BCL2
  5. BCL2L1
  6. BIRC4
  7. CASP1
  8. CASP3
  9. CCL5
10. CCND1
11. CDKN1A
12. CSK
13. CTNNB1
14. CYCS
15. EGF
16. EGFR
17. FADD
18. HRAS
19. IGF1
20. IGF1R
21. IL1B
22. IL8
23. JUN
24. KRT18
25. MAP2K1
26. MAP2K4
27. MAPK1
28. MAPK14
29. MAPK3
30. MAPK8
31. NFKBIA
32. PTGS2
33. PTK2
34. RAF1
35. RELA
36. RIPK1
37. SHC1
38. TCF4
39. TFAP2A
40. TGFB1
41. TGFB2
42. TNF
43. TNFRSF1A
44. TNFRSF6
45. TNFSF6
46. TP53
47. TRADD
```

TABLE 3
Gene list common across Cell Cycle and Colon Cancer

```
  1. BCL2
  2. CASP3
  3. CCND1
  4. CDC25A
  5. CDH1
  6. CDK2
  7. CDK6
  8. CDKN1A
  9. CDKN2A
10. FN1
11. ITGA5
12. ITGB1
13. JUN
14. MAPK8
15. MMP2
16. PLAT
17. PTK2
18. SERPINE1
19. SHC1
20. SP1
21. TFAP2A
22. TGFB1
23. TP53
24. WT1
```

Graph Builder feature of Pathart is used for generating pathway diagrams in Pathart Application. User can select the desired Pathway from the Pathway Tree Panel and view the respective Pathway diagram. (FIG. 22).

Pathart Client is the client UI using which an user can select the desired Pathway from the Pathway Tree Panel.

HttpServerUtil is an inferface between Pathart client and Server. This is a java class and it is applied with façade pattern.

MainServlet is a servlet and gives the entry point to Pathart Server. This Servlet receives the client request from HttpServerUtil and forwards to InteractionMapSearchHandler.

InteractionMapSearchServlet reads the request from input stream and writes the response to output stream. This class sends the read request to InteractionMapSearchHandler for further database operations.

InteractionMapSearchHandler is a java class designed with DAO pattern. This class establishes the connection with Pathart database and passes the search parameters and retrieves the result. This also constructs the result object and sends to InteractionMapSearchServlet.

Pathart Database is an oracle database where all the curated and PDDB data stored across tables. (FIG. 23a & b)

E.g. Building the Pathway Map for ‘EGF Signaling Pathway’ by selecting a pathway from the Pathway tree panel: When the user selecting ‘EGF Signaling Pathway’ from tree panel, the pathway name is put inside a hashtable (requesthash) along with searchType (‘InteractionMapSearch) and sent to HttpServerUtil class. MainServlet receives the request and forwards to InteractionMapSearchServlet.

InteractionMapSearchServlet reads from the input stream and sends the request object to InteractionMapSearchHandler. InteractionMapSearchHandler checks the validity of the request object and then type casts into InteractionMapSearchParam. Database connection is obtained through DBUtil class. The following procedure is called and, InteractionMapSearch.getInteractionsHandle (handle, pathwayName, physiologyName, diseaseName, organismName) procedure searches pathway and interaction_property tables to find the distinct list of interaction ids for the given input parameters. Find the child interaction for all unique interaction_ids and store the data into interaction_map global temporary table. (FIG. 24).

A SQL query is executed to obtain interaction values. Using this values interaction is built. Mapcomponent is built by executing the following procedure.

InteractionMapSearch.getMapComponents(interactionId) procedure joins component, interaction_component and interaction_map tables to find the list of components. It inserts all the components into map_component global temporary table and also it inserts all the complex components into map_component2component global temporary table. By inserting the component_id and interaction_id into interaction_map_intr_comp global temporary table it builds the relationship between components and interactions. It also join response and catalyst tables with interaction_component and interaction_map table to pull effect and catalyst data. (FIG. 25).

INTERACTION MAP table is queried and result set is passed into Linkage class.

From Linkage class values are obtained and the linkage between interactions and map components is built. Then the Graph is built using GraphBuilder and put into the ResultHash. Graph coordinates also added into ResultHash.

InteractionMapSearchServlet writes the response object(ResultHash) into output stream. PathartHelper class reads the response object sent by servlet and sends to PathartApplet. Pathart applet renders the interaction map in Pathway Panel of Pathart. (FIG. 11).

The pathart system data can be ascertained by accessing the external data resources through the web server module as shown in FIG. 1.

1. A computer system for analysis and visualization of signalling and metabolic pathways, said system comprising
a) a plurality of functionally inter-related databases including external database for extracting at least one attribute of a biological entity, a pathway database for storing curated signalling interaction between the biological entities and biological entity data, said plurality of databases including a pathart database,
b) a curator member to generate curated signalling interaction between the biological entities obtained from external sources,
c) said pathway database further comprising a hierarchical arrangement of signalling interactions among the biological entities and biological entity data,
d) said pathart database to store mapped addresses for hierarchically arranged signalling interactions among the biological entities and biological entity data,
e) a processing system including a server module to fetch and/or generate desired pathways dynamically from the stored signalling interactions and biological entities,
f) said processing system to obtain information on the selected biological entities or their interactions from said dynamic pathways,
g) a user interface for creating, querying, and viewing the dynamic pathways, and
h) micro array data captured by a user.

2. The system as claimed in claim 1, wherein the micro-array data consists of the information on genes and their expression data.

3. The system as claimed in claim 1, wherein the parameters for the pathway search are selected from an organism, a physiology, a disease, a pathway or a combination thereof.

4. The system as claimed in claim 1, wherein the hierarchical arrangement of the pathway database is based on organism, physiology, disease and pathways.

5. The system as claimed in claim 1, wherein the curator member is disposed to secure pathway information of biological entities from the external sources selected from scientific journals.

6. The system as claimed in claim 1, wherein the curated data of pathway database are relatively free from data redundancy.

7. The system as claimed in claim 1, wherein the signaling interaction between biological entities further comprises interaction details, mutation, localization, catalysts, reaction, and knockout.

8. The system as claimed in claim 1, the user interface displays the signalling interaction either in tabular form or pathway diagrams.

9. A computer implemented method for pathway search and visualization of signalling and metabolic pathways of biological entities using the system of claim 1, said method comprising the steps of;
a) selecting a search parameter for which pathway is to be obtained,
b) displaying pathways for the selected parameter and selecting the desired pathways,
c) displaying the pathway diagram on the user interface, and
d) selecting a biological entity or signalling interaction of said pathway diagram to extract information on said biological entity or interactions.

10. The method as claimed in claim 9, wherein the pathway is selected from scientific literatures as stored in pathway database.

11. The method as claimed in claim 9, wherein search parameter is selected from an organism, a physiology or a disease, a pathway or a combination thereof.

12. The method as claimed in claim 9, wherein the search result can be viewed in form of a table or as a dynamically generated pathway diagram.

13. The method as claimed in claim 9, wherein the signaling interaction between biological entities further comprises interaction details, mutation, localization, catalysts, reaction, and knockout.

14. A digitally implemented method for component search and visualization of signalling and metabolic pathways for biological entities using the system of claim 1, said method comprising the steps of;
a) selecting at least a component from the pathway database or inputting the same for which pathways are desired to obtain gene data,
b) selecting pathway and displaying the pathway diagram on the user interface for the selected component, and
c) selecting a biological entity or signalling interaction of said pathway diagram to generate information on said biological entity or interactions.

15. The method as claimed in claim 14, wherein the component is selected from selected from genes, proteins and bio-molecules participating in the signalling interaction.

16. The method as claimed in claim 14, wherein the signaling interaction between biological entities further comprises interaction details, mutation, localization, catalysts, reaction, and knockout.

17. The method as claimed in claim 14, wherein the search result can be viewed in form of a table or as a dynamically generated pathway diagram.

18. A digitally implemented method for micro array search and visualization of signalling and metabolic pathways using the system of claim 1, said method comprising the steps of;
a) submitting the desired microarray data on genes for comparative analysis of their expressions at time series,
b) displaying in a hierarchical manner the corresponding information on the selected gene data based on organism, physiology or disease, and pathway,
c) generating pathway diagram for said gene data,
d) displaying the pathway diagram, and
e) selecting a biological entity or signalling interaction of said pathway diagram to generate information on said biological entity or interactions.

19. The method as claimed in claim 18, wherein the micro-array data consists of the information on genes and their expression data.

20. The method as claimed in claim 18, the hierarchical manner is in the order of organism, physiology or disease, pathway and gene data.
